(19) United States
(12) Patent Application Publication
(10) Pub. No.: US 2011/0252956 A1
(43) Pub. Date: Oct. 20, 2011

(54) ARMOR WITH VARIABLE COMPOSITION HAVING METALLURGICALLY BONDED LAYERS

(75) Inventors: Ralph R. Sawtell, Gibsonia, PA (US); Men Glenn Chu, Export, PA (US); Roberto Rioja, Murrysville, PA (US)

(73) Assignee: Alcoa Inc.

(21) Appl. No.: 13/050,802

(22) Filed: Mar. 17, 2011

Related U.S. Application Data
(60) Provisional application No. 61/314,920, filed on Mar. 17, 2010.

(51) Int. Cl. F41H 5/04; B23K 20/00

(52) U.S. Cl. 89/36.02; 228/101; 89/911

(57) ABSTRACT

In one embodiment, two or more layers of aluminum alloys are metallurgically bonded and then wrought to produce an armor product having improved ballistics limits for resistance to armor piercing and fragment simulated projectile threats. In one embodiment, the armor product can include a composition that includes a continuous gradient of two or more aluminum alloy compositions. In one embodiment, the armor product can include layers of different aluminum alloys. In one embodiment, the armor product can include compositions of a mixture of more than one aluminum alloy. This armor may be useful on light armor vehicles having wheels, as well as planes and boats.

### TECHNICAL FIELD

The present invention relates to armor.

### SUMMARY OF INVENTION

Some embodiments of the present invention relate to armor that can include two or more layers of aluminum alloys that are metallurgically bonded having improved armor piercing (AP) resistance and fragment simulated projectile (FSP) resistance. In some embodiments, the armor in accordance with the instant invention can be useful on light armor vehicles having wheels such as the High Mobility Multipurpose Wheeled Vehicle (HMMWV or Humvee) or the Joint Light Technical Vehicle (JLTV).

In some embodiments, the armor in accordance with the instant invention is generally formed from at least two aluminum alloys that may be metallurgically bonded by a variety of processes. In some embodiments, for example, suitable methods for metallurgically bonding the layers include but are not limited to roll bonding, fusion bonding, explosive bonding, or sequential casting as described in U.S. Pat. Nos. 7,377,304 and 7,264,038, each of which are incorporated herein by reference in their entirety. The layered metal composite can be then wrought deformed (e.g. rolled, forged or extruded), tempered (e.g., cold deformed, solution heat treated, quenched, cold rolled, and aged) to form plates or shapes of armor. Before aging, the layered metal composite may be solution heat treated (e.g. at 750° F.-1060° F.) for a sufficient time based on the thickness of the composite. The thickness of the forged and heat treated armor is generally in the range of about 0.25 inches to about 4 inches. For purposes of this description, thickness is defined as the thinnest dimension of the metal. The length and width of an armor plate can be generally in the range of about 2 feet to about 20 feet.

In one embodiment, different functional alloys are selected. For example, the alloy that is ultimately the outward threat-facing side of the armor plate may be a substantially hard alloy that defeats an incoming threat. Moving inward through the thickness of the plate, the following layer may be an alloy that is not as hard, relative to the outward-most layer, but that contains the incoming threat or damage. Moving further inward through the thickness of the plate, a third layer may absorb energy.

In some embodiments, the armor of the present invention achieves an improved armor piercing resistance, fragment simulated projectile resistance, and tensile yield strength (TYS) and/or a combination of two or more of these properties. In one embodiment, the armor achieves a TYS that is at least 35 ksi. In this embodiment, an ultimate tensile strength (UTS) of at least 45 ksi is achieved. In another embodiment, the armor achieves a tensile yield strength that is at least 60 ksi.

As used herein, “armor piercing V₅₀ ballistics limit” and the like means that the armor achieves the stated V₅₀ ballistics limit, as defined in MIL-STD-662F (1997) when tested in accordance with MIL-STD-662F (1997), and utilizing the following conditions:
(a) the round is a 0.30 cal APM2 armor piercing round;
(b) the round is fired using a universal gun mount for 0.30 cal APM2 testing, with a barrel chambered for the 30-06 Springfield cartridge;
(c) the testing sample has a thickness in the range of 1.087 inches-1.575 inches;
(d) the testing sample is located approximately 22 feed from the muzzle of the gun; and
(e) the pass/fail analysis is based on the ability of the armor samples to stop the threat round and protect an aluminum witness plate (Sections 3.41 and 5.2.2 of MIL-STD-662F (1997) located behind the target—the testing sample fails if the witness panel is damaged such that light can pass through it where damage can be caused either by the threat round or by spall from the testing sample; otherwise the testing sample passes.

As used herein, “fragment simulating projectile V₅₀ ballistics limit” and the like means that the armor achieves the stated V₅₀ ballistics limit, as defined in MIL-STD-662F (1997) when tested in accordance with MIL-STD-662F (1997), and utilizing the following conditions:
(a) the round is a 20 mm or 0.50 cal fragment simulating projectile manufactured according to MIL-P-46593A, where the projectile is machined out of 4340 steel and has a blunt nose, has a weight of about 830 grains, an overall length of 0.912 inches, and has a main body diameter of 0.784 inches;
(b) the round is fired in the Medium Caliber Range and from a rifled barrel without the use of sabots;
(c) the testing sample has a thickness in the range of 1.020 inches-1.585 inches;
(d) the testing sample is located approximately 22 feet from the muzzle of the gun; and
(e) the pass/fail analysis is based on the ability of the armor samples to stop the threat round and protect an aluminum witness plate (Sections 3.41 and 5.2.2 of MIL-STD-662F (1997) located behind the target—the testing sample fails if the witness panel is damaged such that light can pass through it where damage can be caused either by the threat round or by spall from the testing sample; otherwise the testing sample passes.

In some embodiments, strength testing, for example, can be conducted in accordance with ASTM B557 AND E8.

### BRIEF DESCRIPTION OF DRAWINGS

FIG. 1 illustrates embodiments of FSP rounds.

FIG. 2 illustrates examples of ingots described herein from which armor is prepared.

FIG. 3 illustrates compositions of ingots described herein from which armor is prepared.

FIG. 4 illustrates tensile properties of an example of armor disclosed herein.

FIG. 5 illustrates tensile properties of another example of armor disclosed herein.

FIG. 6 illustrates tensile properties of yet another example of armor disclosed herein

FIG. 7 compares tensile properties of examples of armor disclosed herein.

FIG. 8 compares the V₅₀ vs. areal density relationship of armor disclosed herein with a 7039 alloy and a 6061 alloy for 0.30 cal AP rounds.

FIG. 9 compares the V₅₀ vs. areal density relationship of armor disclosed herein with a 7039 alloy, a 5083 alloy, and a 5456 alloy for 0.50 cal FSP rounds.

FIG. 10 compares the V₅₀ vs. areal density relationship of armor disclosed herein with a 7039 alloy for 20 mm FSP rounds.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

In one embodiment, an aluminum alloy of a first composition is metallurgically bonded to an aluminum alloy of a second composition.

Suitable alloy compositions include, but are not limited to, alloys of the AA series 1000, 2000, 3000, 4000, 5000, 6000, 7000, or 8000.

Generally, the aluminum alloys of the ballistic resistant products described herein may be any of the above-described alloys, but generally the aluminum alloys are from the 2xxx (with or without lithium), 5xxx, 6xxx or 7xxx families. These alloy may be combined in any suitable combination to produce the products described herein. In one embodiment, the product includes a combination of at least 2xxx and 7xxx alloys. In another embodiment, the product includes a combination of at least 2xxx and 5xxx alloys. In another embodiment, the product includes a combination of at least 5xxx and 7xxx alloys. Other combinations may be used. Furthermore, the products may have a layered structure with distinct alloy layer (e.g., when the product is produced via roll bonding) or a gradient structure that transitions from a first alloy type to a second alloy type (e.g., when the product is produced via simultaneous alloy casting techniques). In one example, the first composition is a 5456 alloy. About 5000 lbs of the first composition is held in a furnace at about 1370° Fahrenheit. The second composition is a 7085 alloy. About 6000 lbs of the second composition is held in a furnace at about 1370° Fahrenheit. The molten metal of the first composition flows from the first furnace-reservoir to the first degasser at a rate of about 80 lbs/minute. The degasser rotates at a constant speed as molten metal is transferred out of the furnace-reservoir. The molten metal of the second composition flows from the second furnace-reservoir to the second degasser, and the second filter, then stops at the closed second control apparatus. After a thickness of about 6 inches of metal of the first composition is in the mold cavity, the first control apparatus is closed. After a thickness of about 7 inches of metal of the first composition is in the mold cavity, the flow of molten metal out of the first furnace-reservoir is stopped. The flow out of a feed chamber such as a furnace-reservoir may be stopped, for example, by using a refractory-type plug or similar device to plug the opening in the feed chamber through which the molten metal is flowing. Alternatively, the flow out of a feed chamber such as a tilt furnace may be stopped, for example, by tilting the reservoir. The molten metal of the first composition that has flowed out of the first furnace-reservoir but did not flow into the mold cavity is drained out, and the first filter replaced. Next, the second control apparatus is opened, and molten metal of the second composition flows into the mold cavity at a rate of about 80 lbs/minute. Just before the thickness of metal in the mold box reaches about 15 inches, the second control apparatus is closed, and the flow of molten metal out of the second furnace-reservoir is stopped. Concomitant with closing the second control apparatus and stopping the flow out of the second furnace-reservoir, the first furnace-reservoir is re-opened and molten metal of the first composition flows to the first degasser, then through the first filter that is replaced, then stops at the closed first control apparatus. When the thickness of the metal in the mold box reaches about 15 inches, the first control apparatus is opened and molten metal of the first composition flows into the mold cavity. Casting continues until a thickness of about 18 inches of metal is in the mold cavity. The resulting ingot has a composition of a continuous gradient between metal of the first and second compositions.

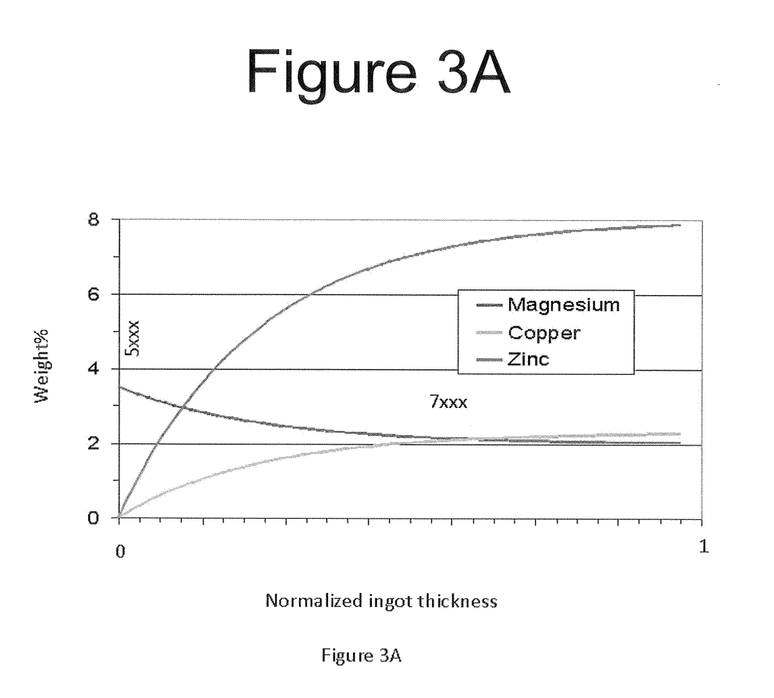

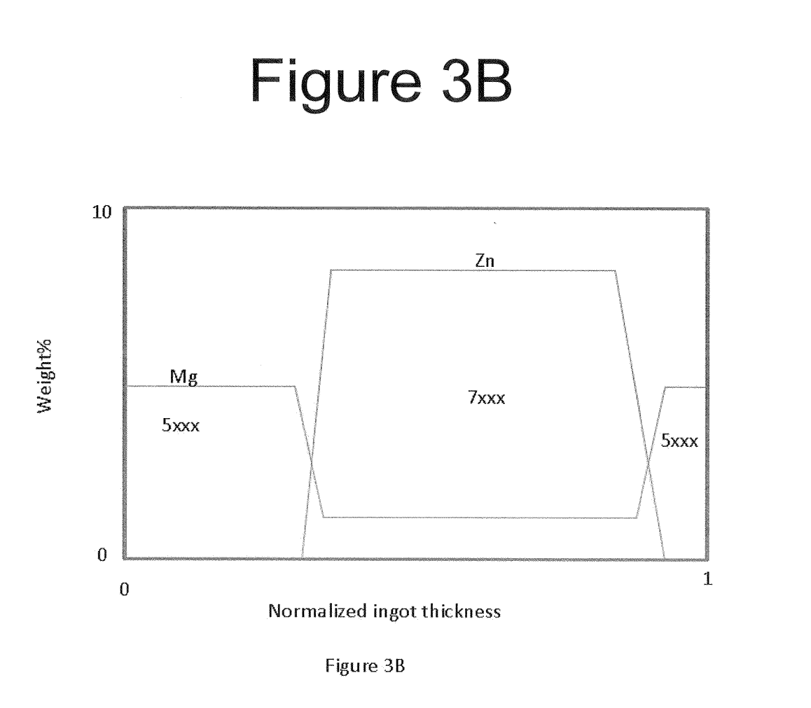

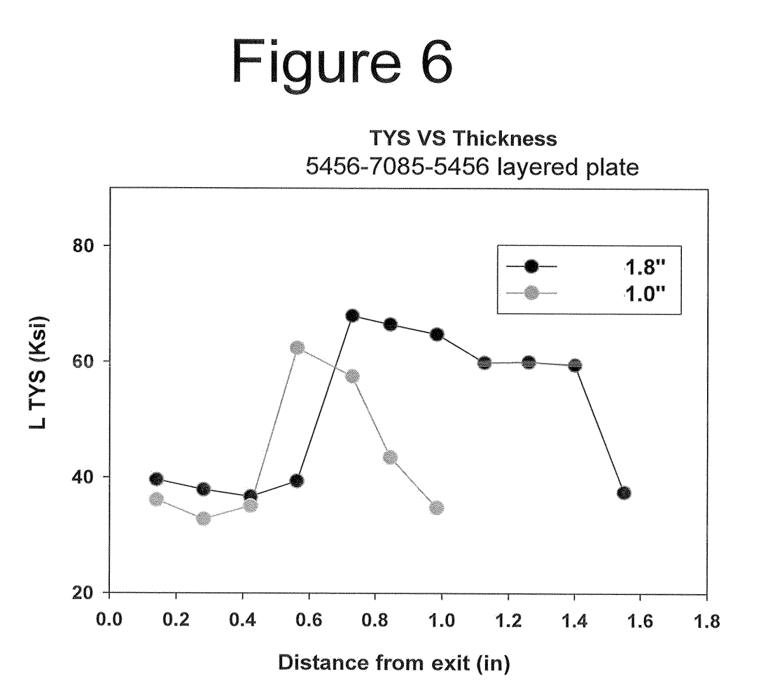

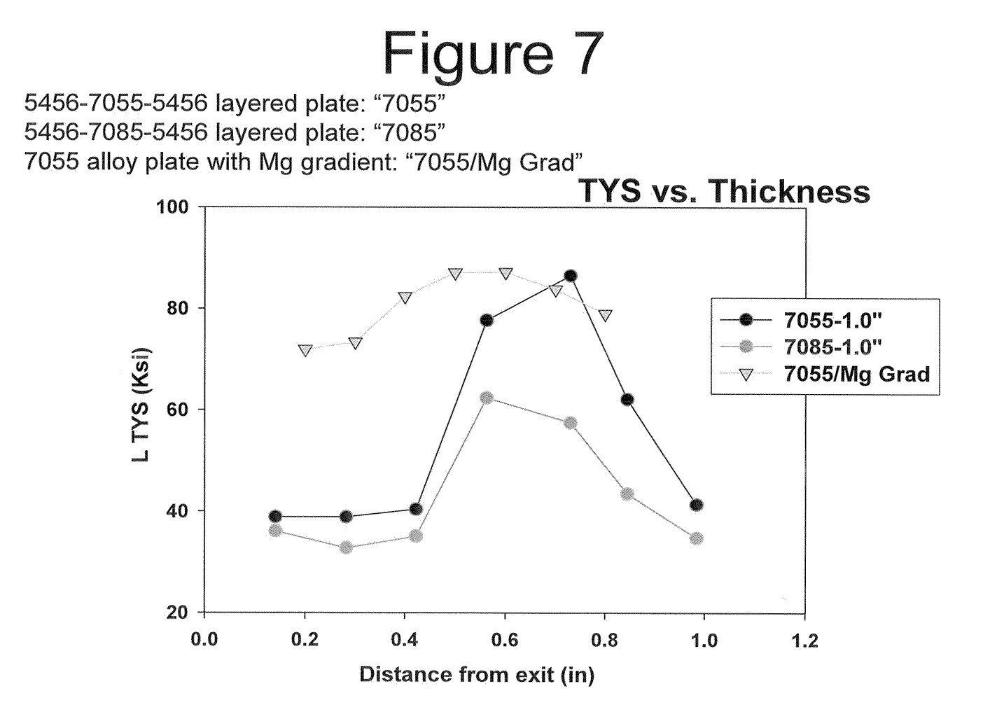

FIG. 3B illustrates the composition through the thickness of this example ingot. FIG. 6 illustrates the tensile properties of armor produced from this example ingot, when samples of approximately 1.8 inch thickness and approximately 1 inch thickness are tested. In testing the TYS illustrated in FIG. 6, slices of approximately 0.1 inches were taken through the thickness of the plate. FIG. 7 compares the tensile yield strength of such armor with the TYS of other examples of armor disclosed herein.

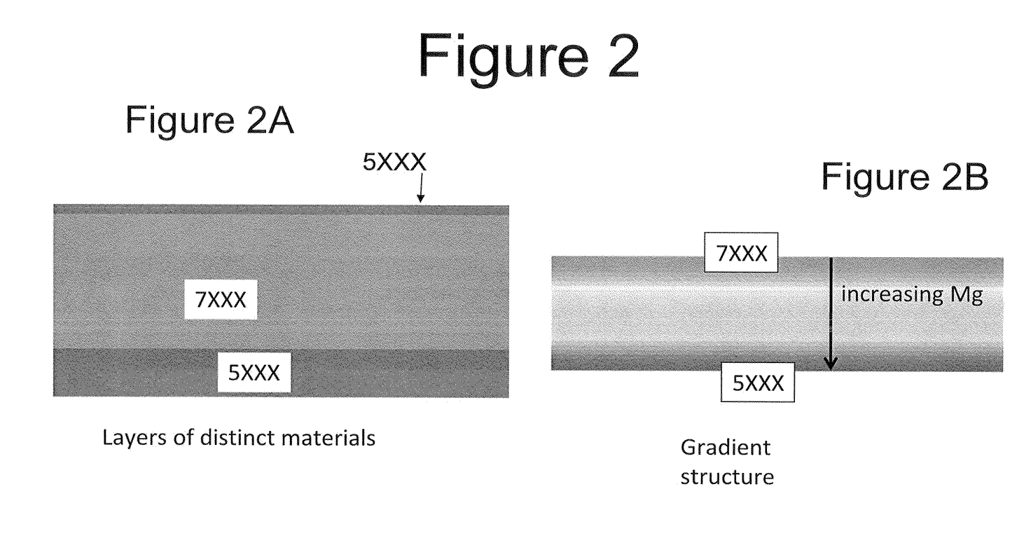

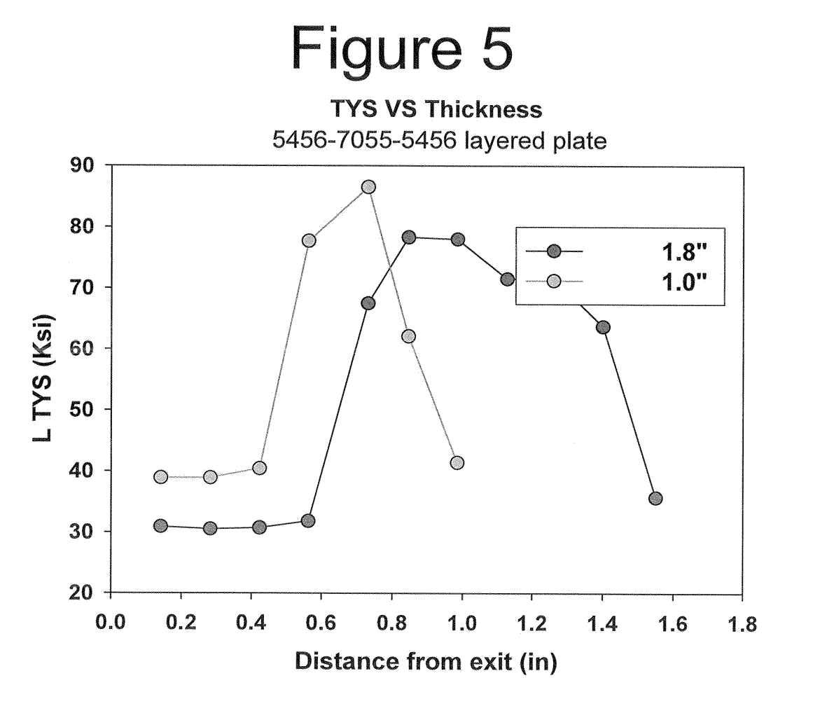

In another example, the first composition is a 5456 alloy and the second composition is a 7055 alloy. FIG. 2A depicts such an ingot. FIG. 3B illustrates the composition through the thickness of this example ingot. FIG. 5 illustrates the tensile properties of armor produced from this example ingot, when samples of approximately 1.8 inch thickness and approximately 1 inch thickness are tested. In testing the TYS illustrated in FIG. 5, slices of approximately 0.1 inches were taken through the thickness of the plate. FIG. 7 compares the tensile yield strength of such armor with the TYS of other examples of armor disclosed herein.

In another example, the compositions are both in AA series 7XXX. In a further example, the first composition is in AA series 6XXX and the second composition is in AA series 5XXX. In yet another example, the first composition is in AA series 7XXX and the second composition is in AA series 6XXX.

The following examples result in an ingot having layers of different compositions, with an interface between the layers that is relatively diffuse, compared to the preceding group of examples.

In one example, molten metal of a first composition is an aluminum alloy that is 6 weight percent magnesium. About 6000 lbs of molten metal of the first composition is in a furnace-reservoir at about 1370° Fahrenheit. Molten metal of the second composition is an aluminum alloy that is 2.5 weight percent magnesium. About 700 lbs of molten metal of the second composition is in a mixing apparatus at about 1350° Fahrenheit. The furnace-reservoir is opened, permitting molten metal of the first composition to flow into the mixing apparatus at a rate of about 80 lbs/minute. Molten metal flows out of the mixing apparatus into a filter, and into the mold cavity. Casting continues with molten metal flowing from the furnace-reservoir into the mixing apparatus, from the mixing apparatus into the filter, and from the filter into the mold cavity until metal in the mold cavity reaches a thickness of about 22 inches. The resulting ingot has a single composition gradient through the thickness, for example the magnesium content. In another example, the mixing apparatus is a degasser that rotates at a constant speed.

In a further example, the first composition is a 5456 alloy and the second composition is a 7055 alloy, wherein the largest composition gradient through the thickness is the zinc content. FIG. 2B depicts such an ingot. FIG. 3A illustrates the composition through the thickness of this example ingot.

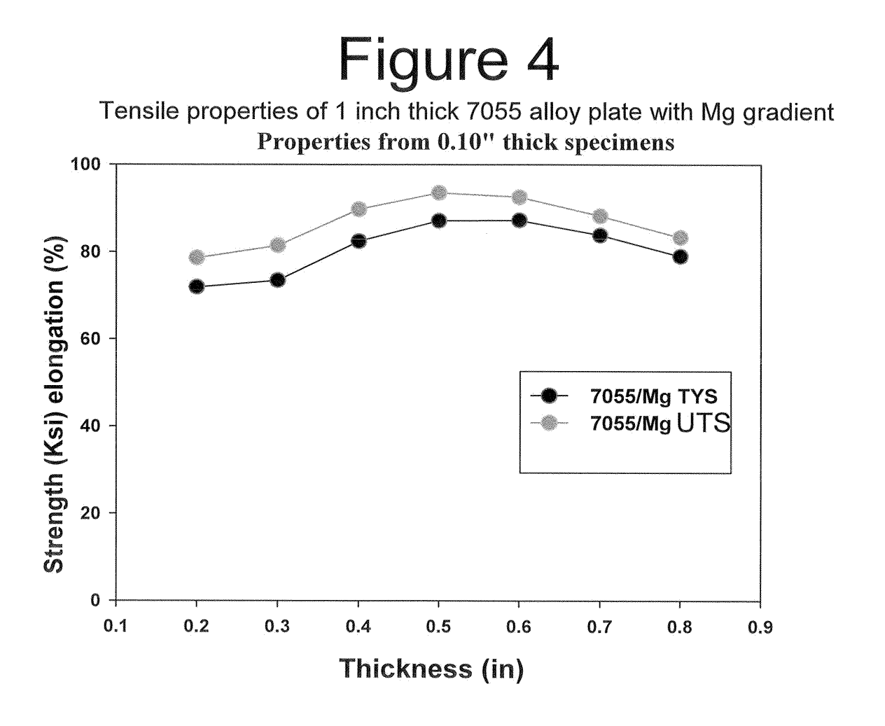

FIG. 4 illustrates the tensile properties of armor produced from this example ingot, when a samples of approximately 1 inch thick is tested. In testing the TYS and UST illustrated in FIG. 4, slices of approximately 0.1 inches were taken through the thickness of the plate. FIG. 7 compares the tensile yield strength of such armor with the TYS of other examples of armor disclosed herein.

In another example, molten metal of a first composition is an aluminum alloy that is 2 weight percent magnesium. About 5000 lbs of molten metal of the first composition is in a first furnace-reservoir at about 1370° Fahrenheit. Molten metal of a second composition is an aluminum alloy that is 5 weight percent magnesium. About 5000 lbs of molten metal of the second composition is in a second furnace-reservoir at about 1370° Fahrenheit. A first programmable control apparatus between the first furnace-reservoir and a degasser located in the casting line is programmed to permit molten metal of the first composition to flow out of the first furnace-reservoir into the degasser at a rate decreasing from, for example, 80 lbs/minute to 0 lbs/minute during a first casting period, for example 16 minutes. The first casting period is determined by determining a first desired thickness of metal to flow into the mold cavity, for example 8 inches. The rate may decrease, for example, linearly, exponentially, or parabolically. The first control apparatus is also programmed to permit molten metal of the first composition to flow out of the first furnace-reservoir into the degasser at a rate increasing from 0 lbs/minute to the original rate at which molten metal of the first composition flowed out of the first furnace-reservoir, for example 80 lbs/minute, during a second casting period, for example, 16 minutes. The second casting period is determined by determining a second desired thickness of metal to flow into the mold cavity, for example 8 inches. The rate may increase, for example, linearly, exponentially, or parabolically. The second control apparatus is programmed to permit molten metal of the second composition to flow out of the second furnace-reservoir into the degasser at a rate increasing from 0 lbs/minute to, for example, the maximum rate at which molten metal of the first composition is permitted to flow, for example 80 lbs/minute, during the first casting period. The rate may increase, for example, linearly, exponentially, or parabolically. The second control apparatus is also programmed to permit molten metal of the second composition to flow out of the second furnace-reservoir into the degasser at a rate decreasing from the maximum rate attained, for example 80 lbs/minute, to 0 lbs/minute during the second casting period. The rate may decrease, for example, linearly, exponentially, or parabolically. When casting begins, the control apparatuses function as programmed, and molten metal flows out of the furnace-reservoirs, into a degasser, into a filter, and into the mold cavity. Casting continues until the metal in the mold cavity reaches a total desired thickness, for example 16 inches. The resulting ingot has a continuous gradient composition across the thickness, for example the magnesium content.

In one embodiment, an ingot formed as described herein is suitably forged, milled, solution heat treated, quenched, cold rolled, and aged to produce the desired thickness and size of the final armor product. In another embodiment, a layered metal composite may be suitably roll bonded, fusion bonded, explosive bonded then milled, solution heat treated, quenched, cold rolled, and aged to produce the desired thickness and size of the final armor product.

The products described in the above examples were generally produce via conventional 7xxx homogenization, solution heat treatment and quench, and artificial aging techniques. With respect to artificial aging, the products of the above examples were generally artificially aged to a conventional T79-type temper, with a cold rolling step prior to aging. However, other tempers may be used based on the ballistics needs, or other needs (e.g., corrosion resistance) of the product. When a 5XXX alloy is used in the product, a cold rolling step will generally be utilized prior to artificial aging.

Suitable thicknesses of the armor product include but are not limited to 0.75 inches, 1 inch, 1.5 inches, 2 inches and 2.5 inches.

12×12 inch target samples are produced from the armor plate having a thickness of approximately 1.1 inches or 1.6 inches. The thickness of the samples is measured at the center of the sample using a coordinate measuring system.

Ballistic Testing

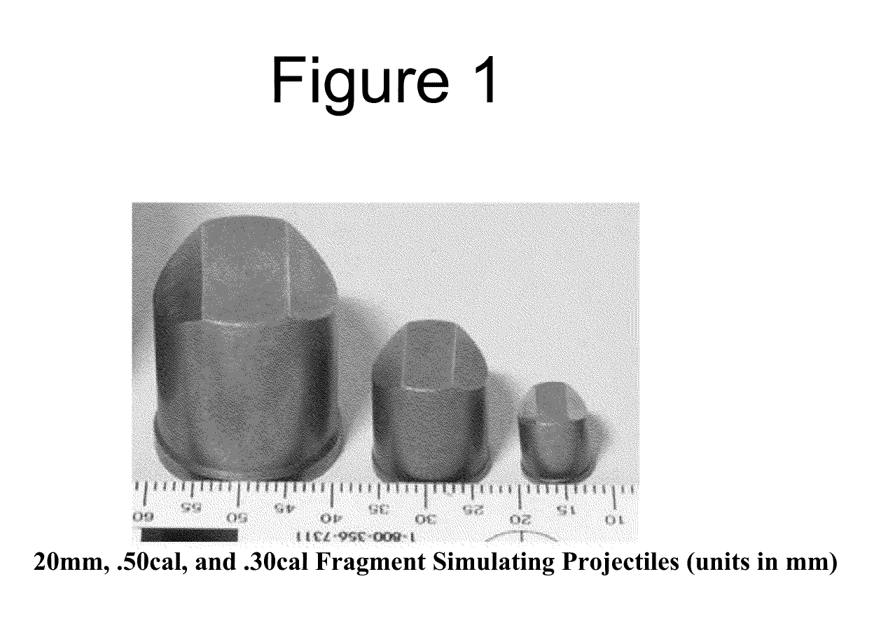

Threat rounds are obtained to test the ballistics performance of the armor samples. For FSP tests, 20 mm and 0.50 cal FSP rounds are used. The FSP rounds are manufactured according to MIL-P-46593A, where the projectile is machined out of 4340 steel and has a blunt nose, has a weight of about 830 grains, an overall length of 0.912 inches, and has a main body diameter of 0.784 inches (all values are average). FIG. 1 illustrates embodiments of FSP rounds.

The AP rounds are American 0.30 cal APM2 rounds obtained from original U.S. military surplus ammunition. These rounds are hand-loaded to achieve the desired impact velocity. The 0.30 cal APM2 is an armor piercing round including a hardened steel core (Rc 63) contained within a copper/gilding metal jacket. A small amount of lead fill is also present in the round. The 0.30 APM2 rounds weigh about 165 grains with the armor piercing core accounting for approximately 80 grains.

FSP Testing Conditions

The armor plates are tested for FSP resistance in accordance with MIL-STD662F (1997). In particular, the FSP rounds are fired in the Medium Caliber Range. The FSP rounds are fired from rifled barrels without the use of sabots. The impact location and target obliquity are confirmed using a bore-mounted laser. All testing is performed in an indoor facility with the muzzle of the gun approximately 22 feet from the armor targets.

AP Testing Conditions

The armor is tested for AP resistance in accordance with MIL-STD-662F (1997). In particular, the AP rounds are fired utilizing a universal gun mount. A barrel chambered for the 30-06 Springfield cartridge is used to fire the APM2 projectiles. A bore mounted laser is used to align the gun with the desired impact locations on the target and to confirm target obliquity. All testing is performed in an indoor facility with the muzzle of the gun approximately 22 feet from the armor targets.

Measurement of Impact Velocities

Projectile impact velocities were measured using two sets of Oehler Model 57 photoelectric choreographs located between the gun and the target. The spacing between each set of chronographs was 48 inches. Hewlett Packard HP 53131A universal counters, triggered by the chronographs, record the projectile time between screens. Projectile velocity is then calculated using the recorded travel times and the known travel distance. An average of the two calculated values is recorded as the screen velocity. The distance from the center of the screens to the impact location is approximately 4.1 feet. Unlike AP rounds, FSP rounds tend to slow down relatively quickly due to their shape. Deceleration is taken into account by using the formulas for deceleration in AEP-55, “NATO AEP-55 VOL 1 ED 1 PROCEDURES FOR EVALUATING THE PROTECTION LEVEL OF LOGISTIC AND LIGHT ARMOURED VEHICLES VOLUME 1.”

Target Holders

The armor targets are held in a rigid target holder for FSP testing. The target holder is constructed out of 2 inch×3 inch×¼ inch structural tubing forming a window frame with two long horizontal supports that are clamped to a large frame. The target is centered in the opening in the target holder which is 8 inches×8 inches. Each of the targets is impacted at the center of the sample.

The target holders for the AP testing is constructed out of steel forming a window frame which is bolted to a large frame. Each of the targets is impacted with multiple AP rounds, spaced 2-inches apart.

Witness Panels

Witness panels are used during testing in accordance with MIL-STD-662F (1997). The panels are produced from a 2024-T3 aluminum alloy and have dimensions of 12 inches by 16 inches with a thickness of 0.020 inches. The witness panels are located approximately six inches behind the rear face of the armor target.

Pass/Fail Criteria

Pass/fail for the testing is based on the ability of the armor sample target to stop the threat round and protect an aluminum witness panel located behind the target. If a witness panel is damaged such that light can pass through the witness panel, a complete penetration (fail) of the armor sample target has occurred. Damage to the witness panel can be caused either by the projectile or spall. A partial penetration (pass) occurs if the witness panel is not perforated during the test.

### Ballistic Results

Table 1 provides a summary of the V₅₀ data for the samples.

TABLE 1
Summary of test results

| | | Alloy | | | |
|---|---|---|---|---|---|
| | | 5456 & 7085 | 5456 & 7085 | 5456 & 7055 | 5456 & 7055 |
| | | Thickness (in) | | | |
| Threat | | 1.082-1.090 | 1.579-1.587 | 1.02-1.092 | 1.573-1.579 |
| 20 mm | V₅₀ | | 3,053 | | 3,405 |
| FSP | | | | | |
| 0.50 cal | V₅₀ | 3,774 | | 4,023 | |
| FSP | | | | | |
| 0.30 cal | V₅₀ | 2,108 | 2,733 | 2,297 | 2,737 |
| APM2 | | | | | |

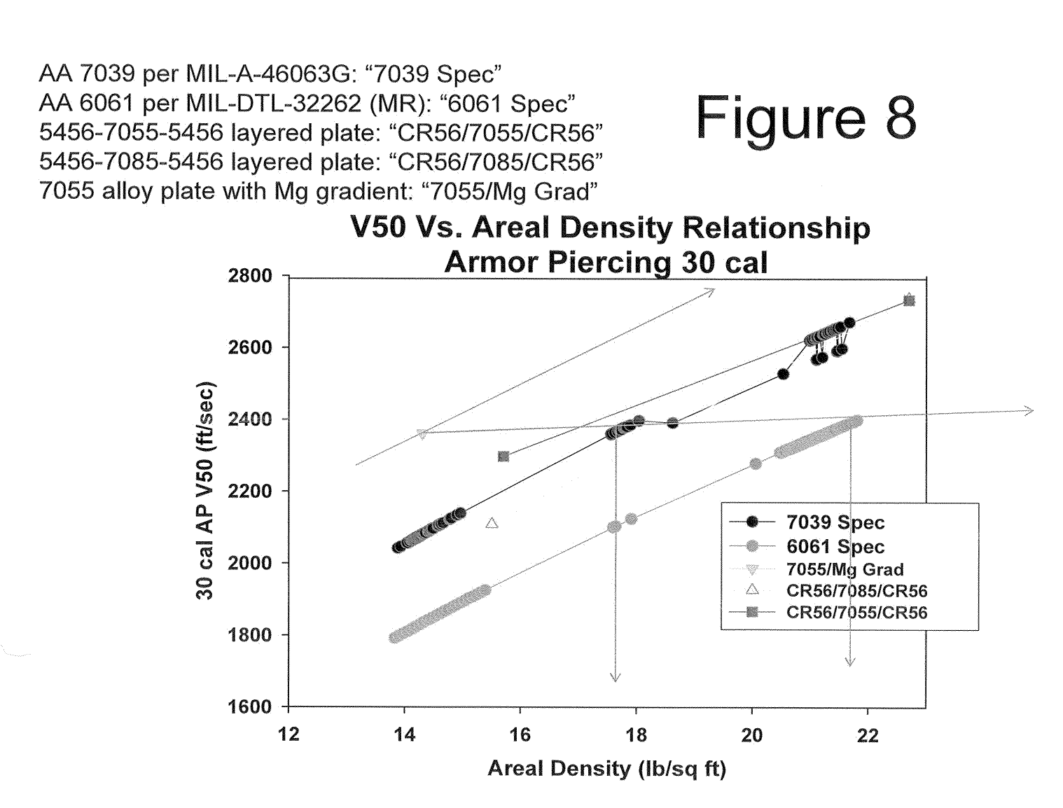

FIG. 8 compares the V₅₀ data of Table 1 for 0.30 cal AP rounds with the V₅₀ data of a 7039 alloy per MIL-A-46063G and the V₅₀ data of 6061 alloy per MIL-A-46063G. The V₅₀ data for each material is plotted against the respective areal density for each material in lbs/square foot

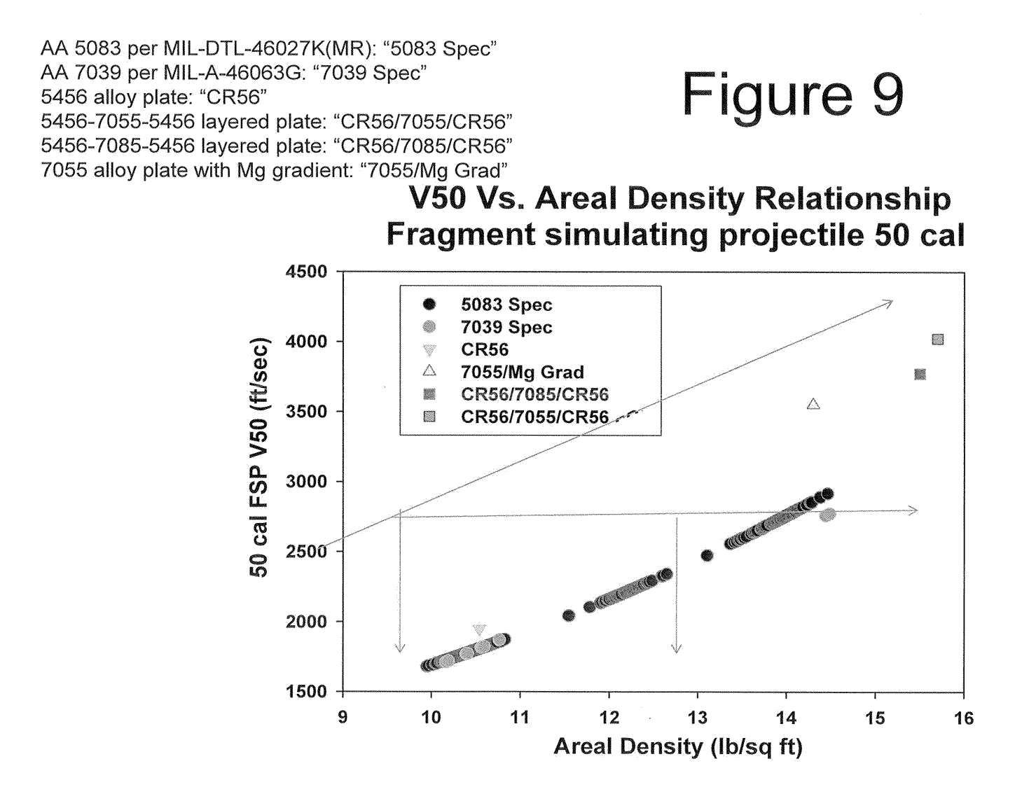

FIG. 9 compares the V₅₀ data of Table 1 for 0.50 cal FSP rounds with the V₅₀ data of a 5083 alloy per MIL-DTL-46027K(MR), the V₅₀ data of a 7039 alloy per MIL-A-46063G, and the V₅₀ data of a 5456 alloy. The V₅₀ data for each material is plotted against the respective areal density for each material in lbs/square foot.

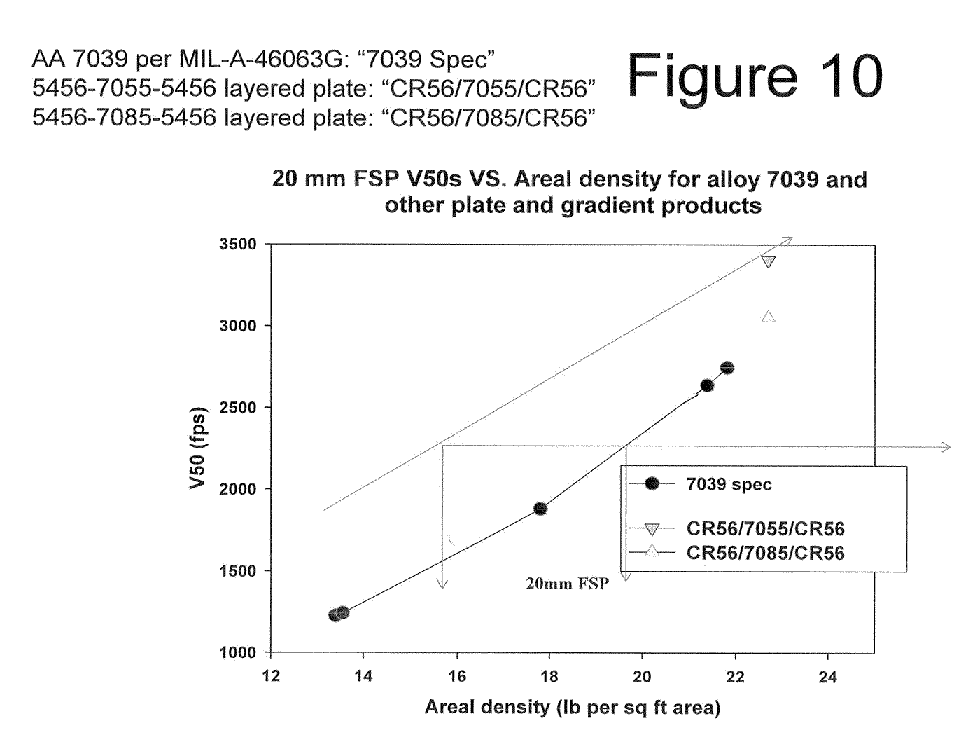

FIG. 10 compares the V₅₀ data of Table 1 for 20 mm FSP rounds with the V₅₀ data of a 7039 alloy per MIL-A-46063G. The V₅₀ data for each material is plotted against the respective areal density for each material in lbs/square foot.

In one example, an armor product in accordance with some embodiments of the instant invention can include at least two layers of aluminum alloys that are metallurgically bonded, wherein the armor product results in a property that includes an armor piercing V₅₀ ballistics limit greater than that of an 5083-H131 armor product having a similar thickness for a threat, wherein the armor product has a thickness that is at least 1.5 times a diameter of the threat.

In a another example, an armor product in accordance with some embodiments of the instant invention can include at least two layers of aluminum alloys that are metallurgically bonded, wherein the armor product results in a property that includes an armor piercing V₅₀ ballistics limit greater than that of an 7039-T64 armor product having a similar thickness for a threat, wherein the armor product has a thickness that is at least 1.5 times a diameter of the threat.

In a further example, an armor product in accordance with some embodiments of the instant invention can include an aluminum alloy composition including a continuous gradient, wherein the armor product results in a property that can include an armor piercing V₅₀ ballistics limit greater than that of an 5083-H131 armor product having a similar thickness for a threat of for a threat, wherein the armor product has a thickness that is at least 1.5 times a diameter of the threat.

In yet another example, an armor product in accordance with some embodiments of the instant invention can include an aluminum alloy composition that includes a continuous gradient, wherein the armor product results in a property that can include an armor piercing V₅₀ ballistics limit greater than that of an 7039-T64 armor product having a similar thickness for a threat of for a threat, wherein the armor product has a thickness that is at least 1.5 times a diameter of the threat.

In any of these preceding examples, the threat is, for example, a .30 caliber APM2 round or a .50 caliber APM2 round.

In any of these preceding examples, the armor product in accordance with some embodiments of the instant invention can include, for example, a top section, a middle section, and a bottom section, wherein the bottom section is composed of an aluminum alloy of a first composition, wherein the top section is composed of an aluminum alloy of a second composition, wherein the middle section is composed of a mixture of the first composition and the second composition.

Alternatively, in any of these preceding examples, the armor product in accordance with some embodiments of the instant invention can include, for example, a first layer, a second layer, a third layer a fourth layer, and a fifth layer wherein the first and fifth layers are composed of an aluminum alloy of a first composition, wherein the third layer is composed of aluminum alloy of a second composition, wherein the second and fourth layers are composed of a mixture of the first composition and second composition.

In another alternative, in any of these preceding examples, the armor product in accordance with some embodiments of the instant invention can include, for example, a top section, a middle section, and a bottom section, wherein the top and bottom sections are composed of an aluminum alloy of a first composition, wherein the middle section is composed of a mixture of the first composition and the second composition.

In one example, an armor product in accordance with some embodiments of the instant invention can include at least two layers of aluminum alloys that are metallurgically bonded, wherein the armor product results in a property that can include a fragment simulating projectile V₅₀ ballistics limit greater than that of an 5083-H131 armor product having a similar thickness for a threat, wherein the armor product has a thickness that is at least 1.5 times a diameter of the threat.

In another example, an armor product in accordance with some embodiments of the instant invention can include at least two layers of aluminum alloys that are metallurgically bonded, wherein the armor product results in a property that can include a fragment simulating projectile V₅₀ ballistics limit greater than that of an 7039-T64 armor product having a similar thickness for a threat, wherein the armor product has a thickness that is at least 1.5 times a diameter of the threat.

In yet another example, an armor product in accordance with some embodiments of the instant invention can include an aluminum alloy composition that can include a continuous gradient, wherein the armor product results in a property that can include a fragment simulating projectile V₅₀ ballistics limit greater than that of an 5083-H131 armor product having a similar thickness for a threat of for a threat, wherein the armor product has a thickness that is at least 1.5 times a diameter of the threat.

In a further example, an armor product in accordance with some embodiments of the instant invention can include an aluminum alloy composition that can include a continuous gradient, wherein the armor product results in a property that can include a fragment simulating projectile V₅₀ ballistics limit greater than that of an 7039-T64 armor product having a similar thickness for a threat of for a threat, wherein the armor product has a thickness that is at least 1.5 times a diameter of the threat.

In any of the preceding examples, the threat is, for example, a 20 mm fragment simulating projectile round or a .50 caliber fragment simulating projectile round.

In one example of an armor product in accordance with some embodiments of the instant invention can include an aluminum alloy composition that includes a continuous gradient, the armor product has a top and a bottom, wherein the continuous gradient:
(i) is a gradient of aluminum alloys of a first and second compositions,
(ii) has an amount of an aluminum alloy of the second composition that decreases gradually from the bottom of the ingot through the thickness to the top of the ingot, and
(iii) has an amount of an aluminum alloy of the first composition that increases gradually from the bottom of the ingot through the thickness to the top of the ingot.

One example of an armor product in accordance with some embodiments of the instant invention can include, in an aluminum alloy composition that includes a continuous gradient, the gradient is substantially linear.

Another example of an armor product in accordance with some embodiments of the instant invention can include, in an aluminum alloy composition that includes a continuous gradient, the gradient is substantially exponential.

In one example, a method in accordance with some embodiments of the instant invention can include:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
   preparing an armor product from the bonded layers, wherein the armor product results in a property that includes an armor piercing V₅₀ ballistics limit greater than that of an 5083-H131 armor product having a similar thickness for a threat,
   wherein the armor product has a thickness that is at least 1.5 times a diameter of the threat.

In another example, a method in accordance with some embodiments of the instant invention can include:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
   preparing an armor product from the bonded layers, wherein the armor product results in a property that includes an armor piercing V₅₀ ballistics limit greater than that of an 7039-T64 armor product having a similar thickness for a threat,
   wherein the armor product has a thickness that is at least 1.5 times a diameter of the threat.

In either of the preceding two examples, the threat is, for example, a .30 caliber APM2 round or a .50 caliber APM2 round.

In one example, a method in accordance with some embodiments of the instant invention can include:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
   preparing an armor product from the bonded layers, wherein the armor product results in a property that includes a fragment simulating projectile V₅₀ ballistics limit greater than that of an 5083-H131 armor product having a similar thickness for a threat,
   wherein the armor product has a thickness that is at least 1.5 times a diameter of the threat.

In another example, a method in accordance with some embodiments of the instant invention can include:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
   preparing an armor product from the bonded layers, wherein the armor product results in a property that includes a fragment simulating projectile V₅₀ ballistics limit greater than that of an 7039-T64 armor product having a similar thickness for a threat,
   wherein the armor product has a thickness that is at least 1.5 times a diameter of the threat.

In either of the preceding two examples, the threat is, for example, the threat is a 20 mm fragment simulating projectile round or a .50 caliber fragment simulating projectile round.

While a number of embodiments of the present invention have been described, it is understood that these embodiments are illustrative only, and not restrictive, and that many modifications may become apparent to those of ordinary skill in the art.

What is claimed is:

1. An armor product comprising:
at least two layers of aluminum alloys that are metallurgically bonded,
wherein the armor product results in a property comprising an armor piercing V₅₀ ballistics limit greater than that of an 5083-H131 armor product having a similar thickness for a threat,
wherein the armor product has a thickness that is at least 1.5 times a diameter of the threat.

2. An armor product comprising:
at least two layers of aluminum alloys that are metallurgically bonded,
wherein the armor product results in a property comprising a fragment simulating projectile V₅₀ ballistics limit greater than that of an 5083-H131 armor product having a similar thickness for a threat,
wherein the armor product has a thickness that is at least 1.5 times a diameter of the threat.

3. An armor product comprising:
at least two layers of aluminum alloys that are metallurgically bonded,
wherein the armor product results in a property comprising an armor piercing V₅₀ ballistics limit greater than that of an 7039-T64 armor product having a similar thickness for a threat,
wherein the armor product has a thickness that is at least 1.5 times a diameter of the threat.

4. An armor product comprising:
at least two layers of aluminum alloys that are metallurgically bonded,
wherein the armor product results in a property comprising a fragment simulating projectile V₅₀ ballistics limit greater than that of an 7039-T64 armor product having a similar thickness for a threat,
wherein the armor product has a thickness that is at least 1.5 times a diameter of the threat.

5. An armor product comprising an aluminum alloy composition comprising a continuous gradient,
wherein the armor product results in a property comprising an armor piercing V₅₀ ballistics limit greater than that of an 5083-H131 armor product having a similar thickness for a threat of for a threat,
wherein the armor product has a thickness that is at least 1.5 times a diameter of the threat.

6. An armor product comprising an aluminum alloy composition comprising a continuous gradient,
wherein the armor product results in a property comprising a fragment simulating projectile V₅₀ ballistics limit greater than that of an 5083-H131 armor product having a similar thickness for a threat of for a threat,
wherein the armor product has a thickness that is at least 1.5 times a diameter of the threat.

7. An armor product comprising an aluminum alloy composition comprising a continuous gradient,
wherein the armor product results in a property comprising an armor piercing V₅₀ ballistics limit greater than that of an 7039-T64 armor product having a similar thickness for a threat of for a threat,
wherein the armor product has a thickness that is at least 1.5 times a diameter of the threat.

8. An armor product comprising an aluminum alloy composition comprising a continuous gradient,
wherein the armor product results in a property comprising a fragment simulating projectile V₅₀ ballistics limit greater than that of an 7039-T64 armor product having a similar thickness for a threat of for a threat,
wherein the armor product has a thickness that is at least 1.5 times a diameter of the threat.

9. A method comprising:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
preparing an armor product from the bonded layers, wherein the armor product results in a property comprising an armor piercing V₅₀ ballistics limit greater than that of an 5083-H131 armor product having a similar thickness for a threat,
wherein the armor product has a thickness that is at least 1.5 times a diameter of the threat.

10. A method comprising:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
preparing an armor product from the bonded layers, wherein the armor product results in a property comprising an armor piercing V₅₀ ballistics limit greater than that of an 7039-T64 armor product having a similar thickness for a threat,
wherein the armor product has a thickness that is at least 1.5 times a diameter of the threat.

11. A method comprising:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
preparing an armor product from the bonded layers, wherein the armor product results in a property comprising a fragment simulating projectile V₅₀ ballistics limit greater than that of an 5083-H131 armor product having a similar thickness for a threat,
wherein the armor product has a thickness that is at least 1.5 times a diameter of the threat.

12. A method comprising:
selecting a first aluminum alloy having a first composition from a group consisting of 1xxx, 2xxx, 3xxx, 4xxx, 5xxx, 6xxx, 7xxx, 8xxx,
selecting a second aluminum alloy having a second composition from a group consisting of 1xxx, 2xxx, 3xxx, 4xxx, 5xxx, 6xxx, 7xxx, 8xxx,
wherein the second composition is different from the first composition,
metallurgically bonding the first aluminum alloy as a first layer to the second aluminum alloy as a second layer,
preparing an armor product from the bonded layers, wherein the armor product results in a property comprising a fragment simulating projectile V₅₀ ballistics limit greater than that of an 7039-T64 armor product having a similar thickness for a threat,
wherein the armor product has a thickness that is at least 1.5 times a diameter of the threat.
